(19) United States
(12) Patent Application Publication
(10) Pub. No.: US 2006/0147190 A1
(43) Pub. Date: Jul. 6, 2006

(54) Camera lens suspension

(76) Inventors: Richard Topliss, Cambridge (GB); Ursula Ruth Lenel, Cambridge (GB); Anthony Hooley, Cambridge (GB); Mark Richard Shepherd, Hertfordshire (GB)

Correspondence Address: NIXON & VANDERHYE, PC, 901 NORTH GLEBE ROAD, 11TH FLOOR, ARLINGTON, VA, 22203, US

(21) Appl. No.: 10/563,098

(22) PCT Filed: Jun. 28, 2004
(86) PCT No.: PCT/GB04/02781

§ 371 Date: Mar. 6, 2006

(30) Foreign Application Priority Data
Jul. 1, 2003 (GB) 0315273.3
Feb. 25, 2004 (GB) PCT GB04 000749

(51) Int. Cl. G03B 3/10

(52) U.S. Cl. 396/133

(57) ABSTRACT

A camera comprises: a support structure 100; a lens holder 120 holding at least one lens 121; a suspension 130 for mounting said lens holder 120 on the support structure 100 to allow relative movement of the lens holder 120 and the support structure; and an actuator for moving said lens holder 120. The suspension 130 includes two link elements 133, 135 each connected at a first end to the support structure 100 by a pivotal connection and at the other, second end to the lens holder 120 by a pivotal connection, the pivotal connections allowing pivoting of the respective link element 133, 135 around a respective pivot axis, all the pivot axes being parallel, and the extent of the two link elements 133, 135 perpendicular to their respective pivot axes being parallel and of equal length.

This invention relates to apparatus for suspending and actuating a lens assembly. It is particularly applicable to such apparatus for use in a camera with an electric-active actuator. It has particular application in micro-cameras in portable data processing or communicating devices.

In recent years, with the explosive spread of portable information terminals known as PDAs and portable telephones, an increasing number of models incorporate a compact digital camera or digital video unit employing a CCD (charge-coupled device) or CMOS (complementary metal-oxide semiconductor) sensor as an image sensor. When such a digital camera or the like is miniaturized using an image sensor with a relatively small effective image-sensing surface area, its optical system also needs to be miniaturized accordingly.

To achieve focussing or zooming, additional drive motors have to be included in the already confined volume of such miniature cameras. Whilst most of the existing cameras rely on variations of the well-known electric-coil motor, a number of other actuators have been proposed as small drive units for the lens system. These novel drive units may include transducers based on piezoelectric, electrostrictive or magnetostrictive material. These transducers or actuators are commonly referred to as electro-active.

Small electro-active actuators with comparably large translation displacements have been recently built using a helical structure of coiled piezoelectric bender tape. Such twice-coiled or “super-helical” devices are found to easily exhibit displacement in the order of millimetres on an active length of the order of centimetres. These structures and variations thereof are described, for example, in the co-owned published international patent application WO-0147041 or by D. H. Pearce et al in: Sensors and Actuators A 100 (2002), 281-286. They are manufactured from multilayer ceramic base material such as lead zirconate titanate (PZT) and sintered at high temperatures into their final shape. The use of such actuators as drive motors for lens systems is described for example in the co-owned published international patent application WO-02/103451.

As drive units adapt to the reduced volume of the compact camera designs, lens suspensions systems, which constrain the motion of the lens holder, have to co-evolve. Lens suspension systems ideally have a low stiffness, resistive force or friction in direction of the desired motion and high stiffness in all other directions.

According to a first aspect of the invention, there is provided a camera comprising a support structure; a lens holder holding at least one lens; a suspension for mounting said lens holder on the support structure to allow relative movement of the lens holder and the support structure; and an actuator for moving said lens holder, wherein the suspension includes two link elements each connected at a first end to the support structure by a pivotal connection and at the other, second end to the lens holder by a pivotal connection, the pivotal connections allowing pivoting of the respective link element around a respective pivot axis, all the pivot axes being parallel, and the extent of the two link elements perpendicular to their respective pivot axes being parallel and of equal length.

According to a second aspect of the invention, there is provided a camera including a support structure; a lens holder holding at least one lens; a suspension for mounting said lens holder on the support structure; and an actuator for moving said lens holder, wherein the suspension includes two link elements each pivotally connected to the support structure at one end and pivotally connected to the lens holder at the other end.

Such a suspension has a low stiffness, resistive force or friction in the direction of the desired motion and high stiffness in all other directions. It is thus suitable for miniaturized cameras, particularly for cameras driven by an electro-active actuator.

As a result of the pivot axes being parallel and the extent of the two link elements perpendicular to their respective pivot axes being parallel and of equal length, the link elements are both constrained to move in unison. Considering imaginary lines between the pivot axes, the suspension remains a parallelogram at all times. This decreases the strain on the pivotal connections which increases the robustness of the suspension as a whole.

In this context, the extent of the link elements between the support structure and the lens holder is considered. Typically the link elements are essentially linear (such as rods or bars), in which case the link elements themselves are parallel, or else the link elements are planar (for example, plates), in which case the planes of the link elements are parallel. However in principle the link elements could have a non-linear or non-planar shape, in which case their extent between the pivotal connections is parallel and of equal length.

The suspension is preferably a type of a four-bar linkage, in which the suspension further includes a first attachment element attached to the support structure, the pivotal connections at the first end of each link element being between the first attachment element and the link elements, and a second attachment element attached to the lens holder, the pivotal connections at the second end of each link element being between the second attachment element and the link elements. Such attachment elements facilitate assembly of the suspension to the lens holder and the support structure.

The invention is applicable to any type of camera, but has particular application to cameras incorporated in a portable electronic device such as a telephone, PDA, etc. Such cameras are required to be relatively small and the present invention facilitates such miniaturisation.

According to a third aspect of the invention, there is provided a camera comprising: a support structure; a lens holder holding at least one lens; a suspension for mounting said lens holder on the support structure to allow relative movement of the lens holder and the support structure in a movement direction; and an actuator for moving said lens holder, wherein the suspension comprises at least two pivotal linkages connected in series between the support structure and the lens holder and interconnected within the series by at least one respective intermediate element, the pivotal linkages being oriented with respect to each other so that the relative movements between the ends of each pivotal linkage in a direction perpendicular to the movement direction compensate for one another, each pivotal linkage comprising two link elements each having a pivotal connection at a first end of the linkage and a second pivotal connection at the other, second end of the linkage, all the pivotal connections allowing pivoting of the respective link element around a respective pivot axis, all the pivot axes being parallel, and the extent of the two link elements perpendicular to their respective pivot axes being parallel and of equal length.

In such a suspension, each pivotal linkage has a construction and operation corresponding to the suspension in accordance with the first aspect of the present invention. Therefore, the same features and advantages apply as described above. In addition, the orientation of the pivotal linkages allows movement perpendicular to the movement direction to be reduced. The disadvantage of a single pivotal linkage is that the resultant motion is not linear. As well as motion along a desired straight axis of movement, there is off-axis motion as the linkage pivots. This can be minimised by arranging the suspension to pivot through a small angle, but that limits the maximum range of movement along the axis (for a linkage of given length) or conversely increases the size of the suspension (for a given range of movement). However, the use of series of linkages in accordance with the second aspect of the invention overcomes this disadvantage by orienting the linkages so that the linkages produce off-axis motions which compensate for each other.

In the simplest case, this is achieved by the suspension consisting of two pivotal linkages of the same size arranged antiparallel to one another. Other more complicated arrangements of pivotal linkages can achieve the same effect.

Such an arrangement of a series of pivotal linkages has particular advantage in allowing much higher degrees of movement in the desired direction without the resultant off-axis movement making the suspension impractical by moving the lens too far from the optical axis. In practice this allows degrees of movement up to an order of magnitude greater than a suspension consisting of a single pivotal linkage. This allows the suspension to have a greater field of use. For example, in some types of camera, the suspension consisting of a single pivotal linkage might only be practical to support movement of lens to change the focus, whereas the suspension comprising a series of pivotal linkages might also support a zoom lens requiring a greater degree of movement to change the magnification.

With all the aspects of the invention, the following features may be advantageously applied.

All said elements of said suspension may be formed integrally from one piece of material, preferably a plastics material, for example selected from a group including polypropylene, polyethylene and polyamide (nylon). This is advantageous in that the suspension is easily manufactured and robust. The pivotal connections may be formed by portions of said piece of material having a smaller thickness than the remainder of said piece of material.

In a first type of embodiment, the pivot axes of the pivotal connections extend around the lens holder.

In second type of embodiment, the pivot axes of the pivotal connections extend outwardly of the lens holder. As compared to the first type of embodiment, this orientation allows the suspension to be more compact in the direction outwardly of the lens holder because the width of the link elements is typically less than the length of the link elements. To view this another way, for a given form factor the length of the links may be longer allowing for a greater degree of movement or a lesser degree of off-axis movement for a given degree of movement.

In a preferred embodiment, the actuator extends around the lens holder leaving a single gap with the suspension located in said gap. This has the advantage of providing a compact arrangement.

In this embodiment, the suspension supports the lens holder at just one side or relative to a cylindrical lens holder within just one sector. The sector, measured by connecting the end points of the longest pivot that is located at the lens holder with the center of the lens holder, is preferably less than 90 degrees. As a result, the lens holder is suspended at a quarter or less of its circumference—excluding the suspension effected by the actuator.

Preferably, the pivotal connections extend along a length which exceeds a tenth, more preferably a third or even a half, of the diameter of the lens holder. This provides the advantage that, as compared to a suspension where this length is shorter, the suspension can sustain a higher torsional force without significant deformation.

In some variants of the invention it may advantageous to limit the amount of rotational motion around the pivoting ends to less that 20 degrees, because, as a result, the lens holder's motion is limited to the equivalent maximum displacement which improves the protection of the actuator.

The entire suspension may be arranged outwardly of the lens holder. However an advantageous alternative is that the link elements extend across the lens holder (although with apertures allowing light to pass through the lens). In this case, the pivotal connections of each link element are on opposite sides of the lens holder. This has the advantage relative to the entire suspension being arranged outwardly of the lens holder that the link elements are lengthened without increasing the size of the suspension outside of the lens holder. Increasing the length of the link elements allows a greater degree of movement or a lesser degree of off-axis movement for a given degree of movement in the desired direction.

To allow better understanding, the following detailed description of embodiments of the invention is given by way of non-limitative example with reference to the drawings.

In the drawings:

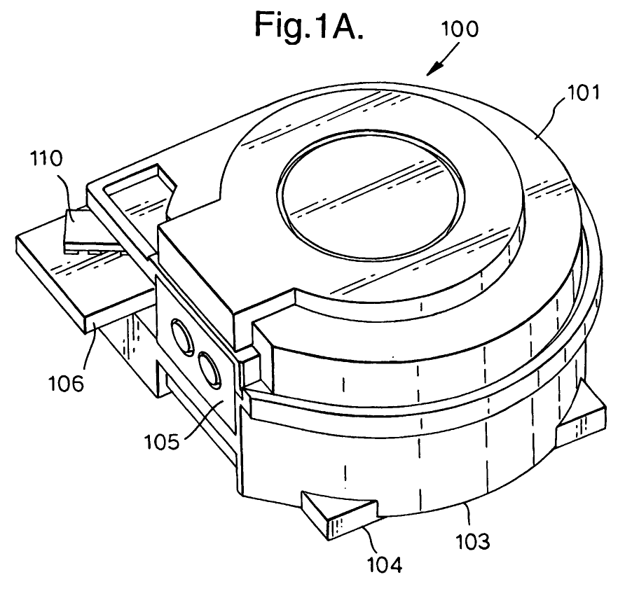

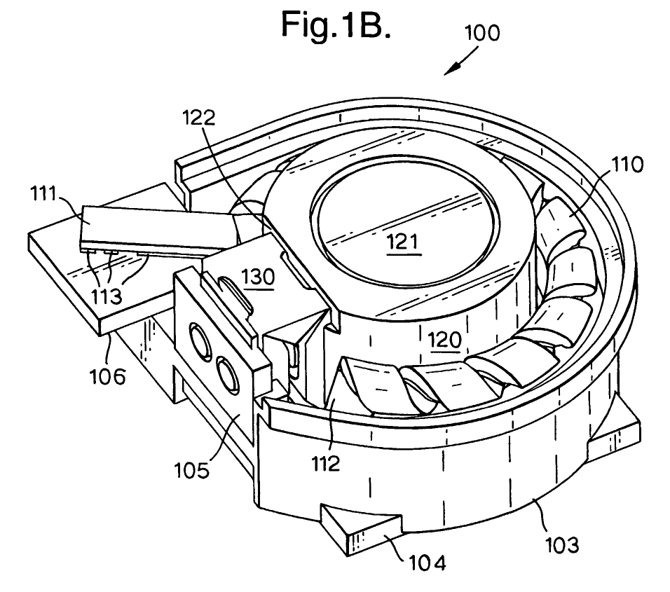

FIG. 1A is a perspective view on a camera housing;

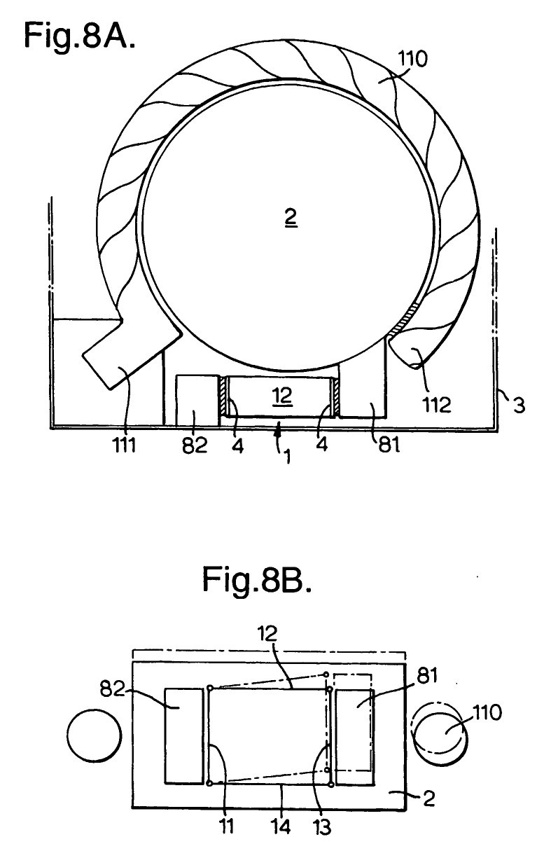

FIG. 1B is a perspective view on the camera housing of FIG. 8A with a top lid removed;

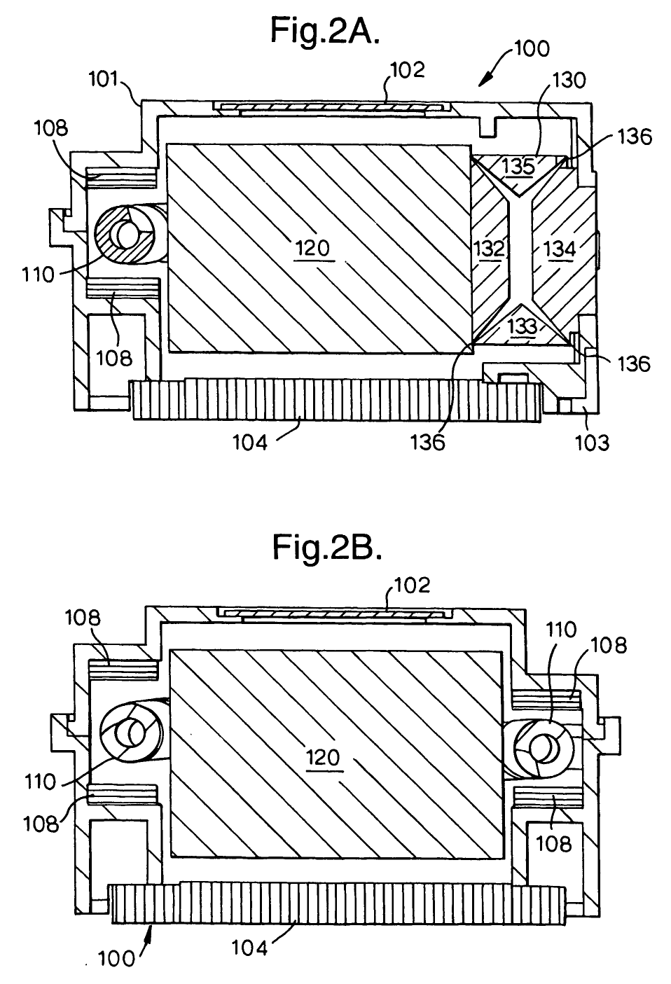

FIGS. 2A and 2B are perpendicular schematic cross-sections of the camera of FIG. 1;

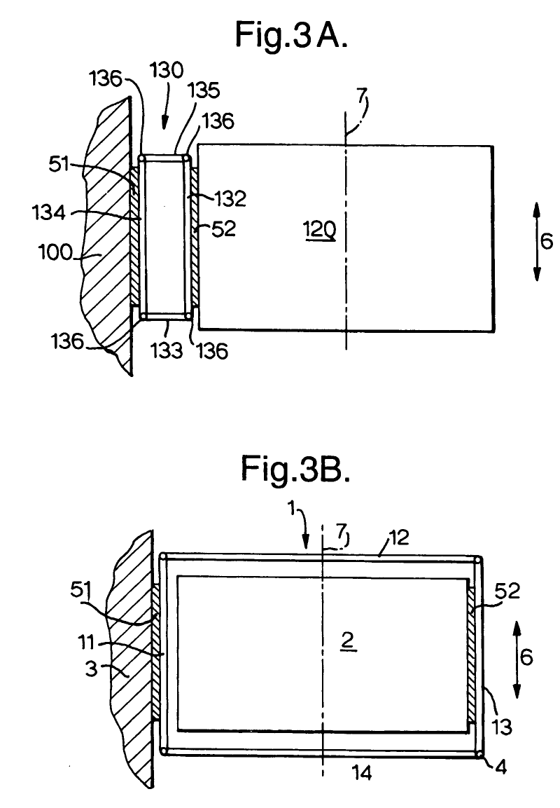

FIG. 3A is a schematic cross-section of the miniature camera of FIG. 2;

FIG. 3B is a schematic cross-section of a miniature camera with an alternative arrangement of the suspension;

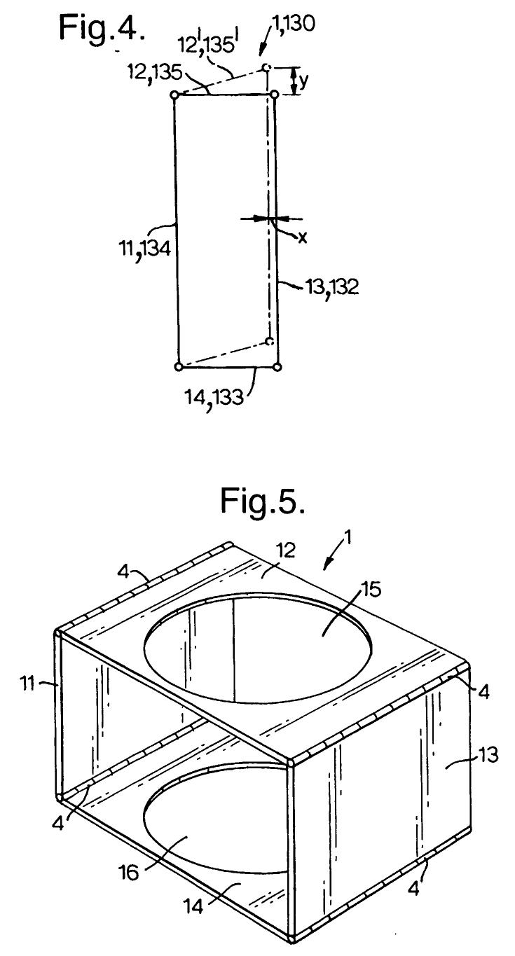

FIG. 4 illustrates the unwanted sideways motion of the suspension;

FIG. 5 is a perspective view of an embodiment of the suspension of the invention;

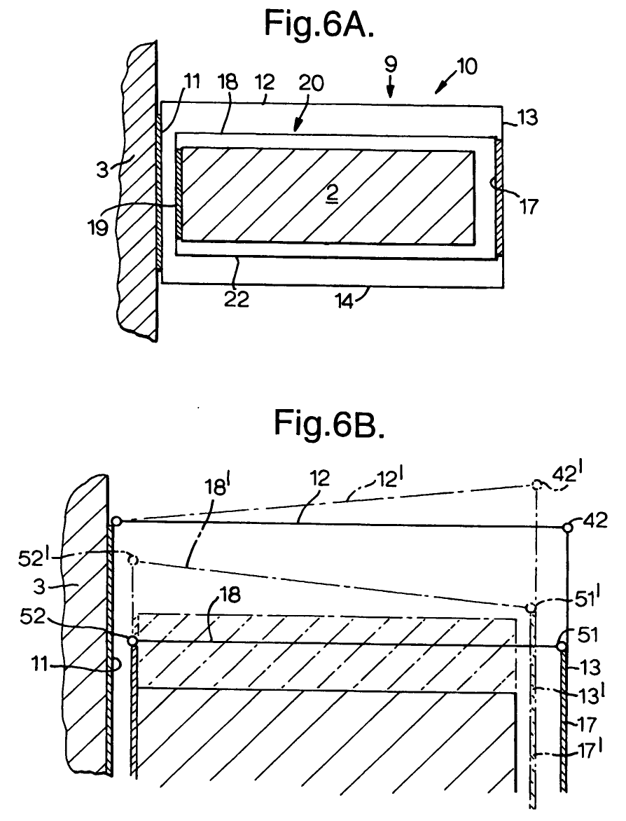

FIGS. 6A and 6B are perpendicular cross-sections of a camera with a double suspension;

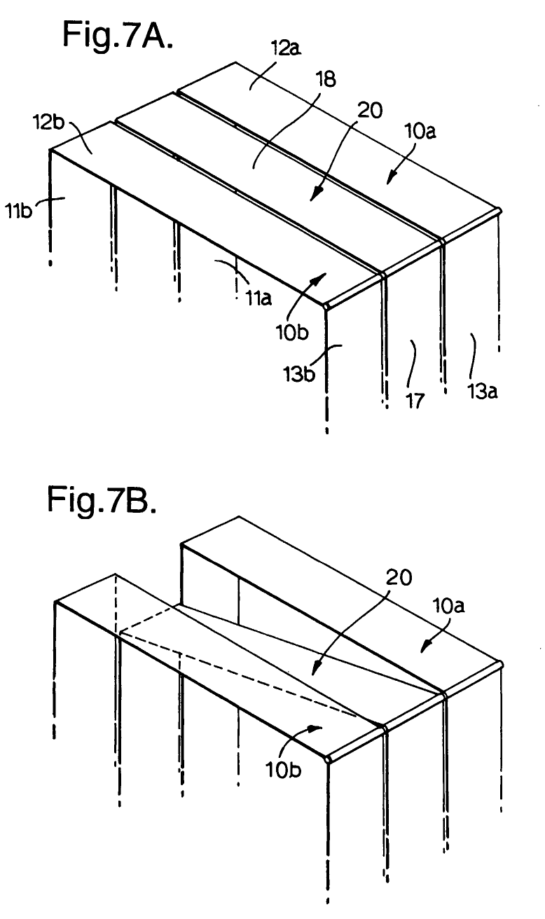

FIGS. 7A and 7B illustrate an interpenetrating suspension;

FIGS. 8A and 8B show a top view and perpendicular cross-section of a camera;

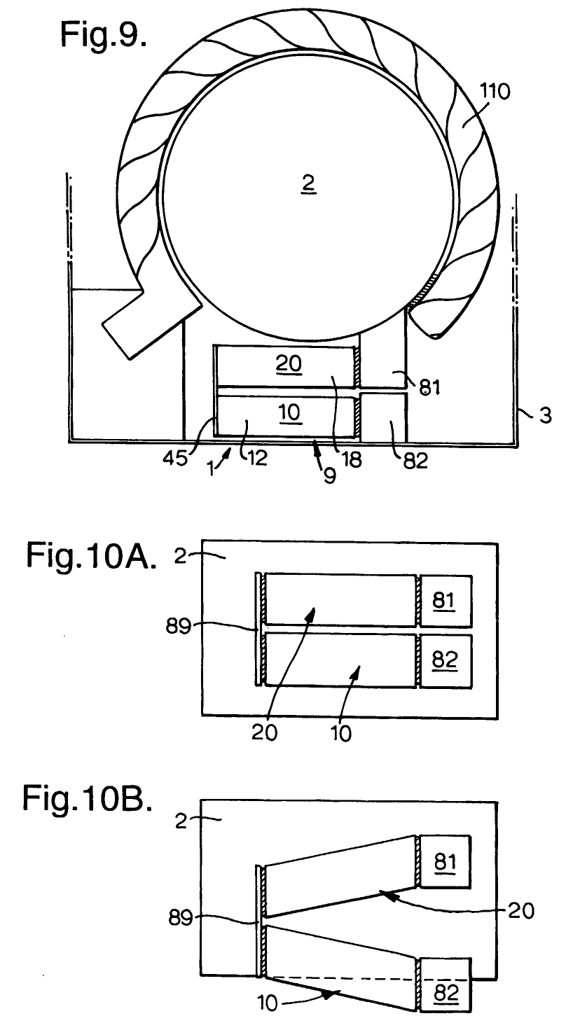

FIG. 9 is a top view of a camera with a double suspension;

FIGS. 10A and 10B are partial side views of a camera with a double suspension; and

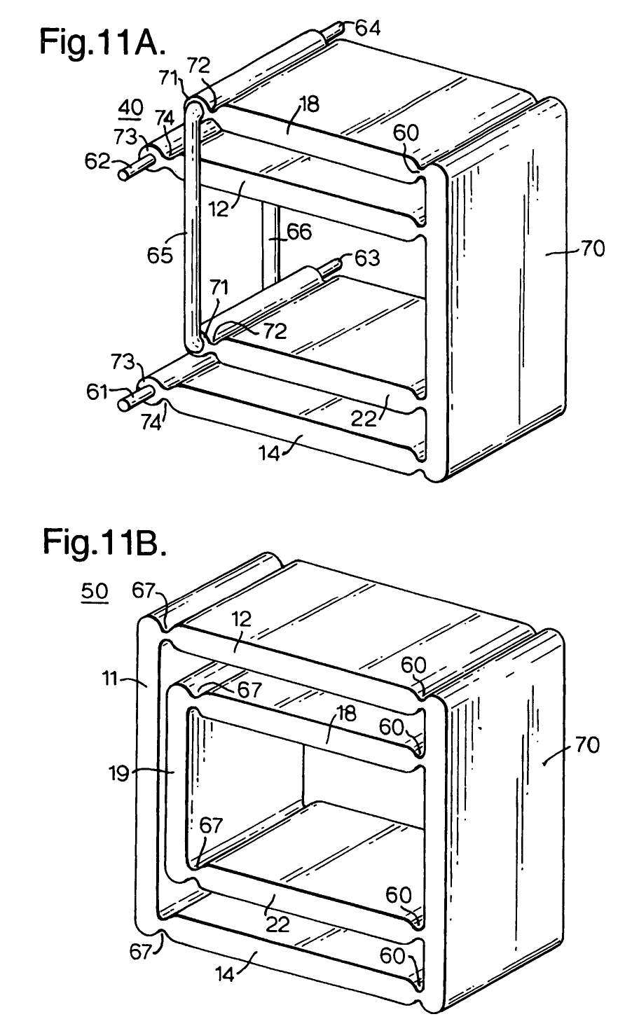

FIGS. 11A and 11B are perspective views of an injection mouldable embodiment of a double suspension.

In FIG. 1A, there is shown a camera housing 100 for a miniature camera. The housing 100 includes a top lid 101 with a central opening or aperture 102 for the passage of light from the exterior into the interior of the housing 100. The opening can be covered by an optical filter. The lower section of the housing 100 includes a bottom lid 103 and a base plate 104 including an image sensor which may be a CCD or CMOS device together with other circuits to capture the image and transmit it to other parts of the camera.

At one side of the housing 100 there is shown an anchor plate 105 which provides mounting points for a suspension 130 described below. Another plate 106 is used to mount the fixed end 111 of a piezoelectric actuator 110.

To further protect the camera and the actuator, the housing 100 may be cast into a block of suitable plastic material.

The housing 100 acts as a support structure for a lens holder 120 as follows. FIG. 1B shows the housing 100 with the top lid 101 removed thus exposing the lens holder (or barrel) 120 with a first upper lens 121 visible. The lens holder 120 has a nominally cylindrical shape that is flattened along one side 122 to provide a mounting surface for the suspension 130. The lens holder 120 is axially movable relative to the housing 100 to allow focusing.

The actuator 110 comprises a piezoelectric multi-layer, bender tape, for example of a bimorph construction, extending helically around an axis which is itself curved, as described, for example, in WO-01/47041 or D. H. Pearce et al., Sensors and Actuators A 100 (2002), 281-286 which are both incorporated herein by reference and the teachings of which may be applied to the present invention. In particular, the actuator 110 comprises a tape wound helically around a first axis, referred to as the minor axis. The helically wound portion is further coiled into a secondary winding of about three quarters of a complete turn. The axis of this secondary winding is referred to as the major axis. The first winding is known as the primary winding or primary helix. Although in this embodiment the secondary winding is about three-quarters of a complete turn, in general, the secondary winding could be any curve and could exceed one turn and form a spiral or secondary helix. It is therefore usually referred to as secondary curve. The tape is arranged on actuation to bend around the minor axis. Due to the helical curve around the minor axis, such bending is concomitant with twisting of the actuator 110 around the minor axis. Due to the curve around the major axis, such twisting is concomitant with relative displacement of the ends 111, 112 of the actuator 110.

The lens holder 120 is placed in the center of the actuator 110. The moving end 112 of the actuator 110 is attached to the lens holder 120 at a point or area at mid-height of the lens holder 120, i.e., close to its equator. Consequently, actuation of the actuator 110 drives movement of the lens holder 120 relative to the housing 100. This type of lens suspension and actuation system is described in greater detail in WO-02/103451, which is incorporated herein by reference and the teachings of which may be applied to the present invention.

The fixed end 111 of the actuator 110 extends into a flat portion which acts as a tab for connecting the actuator 110 to the housing 100. This tab has electrical contact pads 113 on the bottom face, soldered onto corresponding contact points on the board 106. Through these contacts external control signals or voltage levels are applied to the electrodes of the actuator 110.

The suspension 130 will now be described, with reference to FIG. 2A which is a cross-sectional view of the suspension 130.

The suspension 130 is a specific form of a four-bar linkage comprising four elements 132-135 pivotally connected together in the shape of a parallelogram as follows.

The first element of the suspension 130 is a first attachment element 132 rigidly attached to the housing 100, by way of the anchor plate 105.

The second element of the suspension 130 is a second attachment element 134 rigidly attached to the lens holder 120.

The remaining two elements of the suspension 130 are two link elements 133, 135 which each extend, parallel to each other, between the first and second attachment elements 132, 134 and are pivotally connected to the first and second attachment elements 132, 134 as follows. The elements 132-135 are integrally formed from a single, continuous piece of material in the form of a loop. The thickness of the continuous piece of material forming the suspension 130 is reduced in the portions 136 between the elements 132-135, which portions therefore allow relative pivoting of each adjacent pair of elements 132-135 and so may be considered as forming respective pivotal connections. The portions 136 extend parallel each other so the pivotal connections have parallel pivot axes. The elements 132-135 taper towards the portions 136 forming respective pivotal connections. The remainder of each element 132-135 remains relatively stiff, and so does not bend significantly relative to the pivoting motion.

The link elements 133, 135 have the same length. The attachment members 132, 134 also have the same length, so that the link elements 133, 135 extend parallel to one another. As a consequence, the suspension 130 offers small resistance against motion of the lens holder 120 in the desired (vertical) direction but much greater resistance against motion in other directions. During motion of the lens holder 120 in the desired direction, the link elements 133, 135 pivot relative to the attachment elements 132, 134, the elements 132-135 remaining in the shape of a parallelogram. The elements 132-135 and, hence, the portions 136 which connect each adjacent pair of elements 132-135 have a width of about 4 mm and the nominal diameter of the lens holder 120 is 9.5 mm, thus effectively preventing a rotational or tilting movement of the barrel.

In the suspension 130, all the elements 132-135 are planar and so the elements 132-135 themselves are shaped as a parallelogram. In the general case, the elements 132-135 could have other shapes provided that the extent of the link elements 133, 135 perpendicular to the pivot axes of the pivotal connections are parallel and of equal length, ie that imaginary lines perpendicular to the pivot axes of the pivotal connections form a parallelogram.

Each of the portions 136 which connect each adjacent pair of elements 132-135 (ie the pivotal connections) extends linearly in the direction of its axis of relative rotation around the lens holder, in particular along the circumference of the lens holder 120, thus providing resistance to torsional forces which otherwise could lead to a tilting of the suspended camera. The length of the portions 136 which connect each adjacent pair of elements 132-135 in the above example is approximately a third to half of the diameter of the lens holder.

In the example, the suspension 130 is preferably made from a single piece of polypropylene. Other suitable plastic materials include polyethylene or polyamide (nylon). Alternatively the bars of the suspension can be made from metals or metal alloys. The suspension can be cast or injection molded.

It will be appreciated that the lens holder 120 is suspended solely by means of the suspension 130 and the actuator 110. The system is free of further potential sources of friction such as guide rails or posts to reduce the potential amount of force the actuator has to provide. It was found that even though the suspension 130 connects to the lens holder 120 exclusively within a sector of less than 90 degrees, and both the actuator 110 and the suspension 130 are linked to the lens holder 120 within a sector of less than 120 degrees, the tilt of the lens holder 120 can be kept within the limits required to generate pictures in VGA or SVGA quality.

The camera assembly shown in FIGS. 2A and 2B also has protective structures, in particular in the form of compliant polyurethane foam layers 108 glued to inner surfaces of the housing 100 around the actuator 110. The layers 108 protect the actuator 110 from a sudden impact force, particularly if the force accelerates the actuator 110 in a direction that is not constrained by the suspension 130. In FIGS. 2A and 2B, this direction is the vertical direction in the paper plane. The distance between the actuator 110 in its inactive state, and the foam layers 108 increases towards the moving end of the actuator, so as not to interfere with the nominal displacement of the actuator during the normal operation of the camera.

Further alternative embodiments of the invention will now be described with particular reference to the form of the suspension which in each case may be used to replace the suspension 130 in the camera housing 100. For brevity, the following description focuses on the differences, and so apart from those differences the above description of the miniature camera shown in FIGS. 1 and 2 and in particular the suspension 130 applies equally to the following embodiments.

FIG. 3A is a simplified schematic cross-section of the suspension 130 of FIG. 1 while FIG. 3B, in the same format, shows an alternative embodiment. The suspension 130 comprises four elements 132-135, connected together at their ends by portions 136 which act as pivotal connections (represented by solid circles), forming a parallelogram shape. In FIG. 3A, the external face of the first attachment element 132 is fixed to the lens holder 120. The external face of the second attachment element 134, is fixed to the housing 100. The fixings are shown as glue lines 51,52 for clarity, but the fixing mechanism may be any suitable, including mechanical fixings such as nuts and bolts as well as adhesive bonds. When the lens holder 120 is caused to move up and down by an actuator or motor (not shown), the elements 132-135 of the suspension 130 move about the portions 136 such that the lens holder 120 moves accurately in the direction shown by the double-headed arrow 6, that is, parallel to the optical axis 7.

FIG. 3B shows an alternative suspension 1 which is the same as the suspension 130 except for having a different arrangement with respect to the lens holder 2, as described below. In particular, the suspension 1 has link elements 12, 14 which extend across the lens holder 2 so that the portions 4 of the suspension 1 which act as pivotal connections for each one of the link elements 12, 14 are on opposite sides of the lens holder 2. Thus, an external face of the second attachment member 11 is attached to the housing 3, but the lens holder 2 is fixed to an internal face of the first attachment element 13, rather than an external face as in the first attachment element 132 of the suspension 130.

In the suspension 1, the link elements 12, 14 are greatly extended compared to the link elements 133, 135 shown in FIG. 3A, extending beyond the far side of the lens holder 2. As before, when the lens holder 2 is caused to move up (or down) by an actuator (not shown), the link elements 12, 14 pivot about the portions 4 of the suspension 1 which act as pivotal connections such that the first attachment element 13, together with the lens holder 2, moves upwards (or downwards) accurately parallel to the housing 3 and the optical axis 7.

The suspension 1 of FIG. 3B is more compact than the suspension 130 of FIG. 3A, as the lens holder 2 is located in the space inside the suspension 1, whereas in the suspension 130, the space is empty. In a typical miniature camera device, the diameter of the lens holder is of the order of 10 mm and the vertical lens movement required for focussing is of the order of 200-300 microns. To allow such vertical movement without excessive sideways movement, the suspension needs to have a horizontal dimension of at least 2-3 mm. Thus the suspension 130 of FIG. 3A adds 20-30% to the diameter of the camera assembly while the extended suspension 1 of FIG. 3B adds negligible bulk as it wraps neatly around the lens holder 2.

On operation of the suspension 1, vertical movement is accompanied by a lesser amount of sideways movement. This is illustrated in FIG. 4 which is a magnified view of the suspension 1 of FIG. 3A. When the first attachment element 13 is caused to move upwards, the suspension 1 takes the shape shown by the dotted lines in FIG. 4. The first attachment element 13 moves upwards but also moves sideways. For example, in a suspension 130 of the type shown in FIG. 3A, in which the length of the link elements 133, 135 is 2 mm and the vertical movementy is 250 microns (0.25 mm), by simple geometry, when the link element 135 has moved to the position of the dotted line 135′, the horizontal displacement x is 16 microns. Thus the lens holder 120 and lens it contains, and hence the optic axis 7, moves sideways 16 microns. Such sideways, off-axis motion misaligns the lens with respect to the image sensor chip and any other lenses (or lens groups) in the optical system, possibly causing impairment of image quality.

In contrast, the alternative suspension 1 of FIG. 3B suffers much less sideways motion. If the length of the link elements 12, 14 is 10 mm (to fit around a lens holder of diameter 8 mm say) and the vertical displacement y remains the same as before at 250 microns, the horizontal displacement x is 3 microns. Thus the sideways movement of the lens has been reduced by a factor of 5, greatly reducing the misalignment with respect to other lenses and the image sensor.

A perspective view of the suspension 1 of FIG. 3B is shown in FIG. 5. The four elements 11-14 are essentially plates connected by portions 4 which act as pivotal connections. The portions 4 have significant length, conferring lateral and rotational stability on the device. The suspension 1 is designed to hold the lens holder (not shown) in its interior. The link elements 12 and 14 have circular openings 15, 16 to allow passage of light into the lens of the camera. The openings 15,16 as shown are large enough to allow the lens assembly to pass through as it moves up and down. In an alternative design, the full extent of lens assembly travel may be within the vertical bounds of the suspension 1. In that case, the circular openings 15, 16 may be of much smaller diameter, sufficient only to allow passage of light to and from the lens.

As described above, the movement of the lens required for focussing in a miniature camera is of the order of 250 microns. In zoom mechanisms, the motion required is of the order of 2-3 mm. Such a vertical movement is clearly not feasible with a suspension such as that shown in FIGS. 1 and 2, where the horizontal extent of the link elements 133, 135 is only about 2 mm. However, with an extended suspension 1 as shown in FIGS. 3B and 5, the horizontal extent of the upper and lower link elements 12, 14 is of the order of 10 mm and vertical lens motion of 2 mm can be readily achieved. Thus such a suspension can be used to suspend a zoom lens in a miniature camera.

When used for a zoom lens, the sideways motion of the suspension 1 during full vertical motion may once again become critical. With the dimensions noted above (10 mm horizontal link elements, 2 mm vertical motion), sideways motion is of the order of 24 microns. In cameras where such misalignment is unacceptable, which may be the case for example in cameras with multi-megapixel sensors, an additional balancing device may be employed in which the suspension comprises a series of linkages, each corresponding to the suspension 130 or suspension 1 and oriented so that the motions between the ends of each linkage in the desired movement direction of the lens holder accumulate, but the motions between the ends of each linkage in the perpendicular direction compensate for one another, preferably exactly. In the simplest case, the suspension comprises two such linkages of equal length aligned in antiparallel directions. An example of such a suspension will now be described, this being suspension 9 shown in FIG. 6A.

The suspension 9 comprises a linkage 10 and a linkage 20 connected in series between the housing 3 and the lens holder 2. Each linkage 10 and 20 is in itself identical to the suspension 1.

The first linkage 10 has two link elements 12, 14 each pivotally connected to a first attachment element 13 and a second attachment element 11. The second attachment element 11 is attached to the housing 3 at one end on the left of FIG. 6A.

The second linkage 20 has two link elements 18, 22 each pivotally connected to a first attachment element 19 and a second attachment element 17. On the right of FIG. 6A, the second attachment element 17 of the second linkage 20 is attached to the first attachment element 13 of the first linkage 10. The second attachment element 17 of the second linkage 20 and the first attachment 13 of the first linkage 10 together constitute an intermediate element interconnecting the two linkages 10 and 20. They are illustrated as separate elements attached together for ease of understanding, but in practice and in some of the embodiments described below, they may in fact both be constituted by the same single element. The lens holder 2 is attached to the internal face of the first attachment element 19 of the second linkage 20. Thus the link elements 12, 14 of the first linkage 10 and the link elements 18, 22 of the second linkage 20 extend in antiparallel directions across the lens holder 2 in the same manner as the suspension 1.

An expanded schematic view of the upper part of the suspension 9 of FIG. 6A is shown in FIG. 6B to illustrate the balancing mechanism. The position of the various elements when the camera 2 is displaced upwards is shown by dashed lines and primed numerals e.g. the displacement of link element 12 is denoted by the dashed line marked 12′. The first linkage 10 is grounded at the left-hand side (by its second attachment element 11 attached to the housing 3) such that on displacement, the first attachment element 13 of the first linkage 10 moves upwards and inwards, that is to the left. The second linkage 20 is grounded at the right-hand side (by its second attachment element 17 fixed to the first attachment element 13 of the first linkage 10) such that on displacement, the first attachment element 19 of the second linkage 20 moves upwards and inwards, that is to the right. The horizontal lengths of the two suspensions 10 and 20 are approximately equal and the stiffnesses of all hinges are approximately equal, so the opposite inward displacements of the two suspensions 10 and 20 will be approximately equal and therefore compensate each other. Thus the lens holder 2 will move upwards in the movement direction, but neither to left nor right perpendicular to the movement direction. The vertical displacement of the lens holder 2 is illustrated by the line 21 denoting the top of the lens holder 2, which moves to the position marked 21′.

The parallelogram shape of both linkages 10 and 20 constrains the lens holder 2 to move accurately vertically. That is, the lens holder 2 neither tilts nor displaces sideways. Such a balanced suspension 9 therefore allows very considerable vertical movement (many mm) without any misalignment of the lens holder 2. It is therefore suitable for use in a zoom mechanism and in cameras with high resolution.

The balanced suspension 9 of FIG. 6 is shown with the horizontal dimension of the second linkage 20 as somewhat shorter than that of the first linkage 10. This will result in some minimal (probably negligible) sideways movement of the lens holder 2. However, even this minimal sideways motion can be removed if the balanced suspension is designed with equal horizontal dimensions, which can be achieved in designs in which the two suspensions are inter-penetrating. A simple illustrative example is shown in FIG. 7, although many other interpenetrating designs are possible within the scope of the invention.

In FIG. 7A, the upper portion of an example of an interpenetrating balanced suspension 9 is shown. The first linkage 10 is in two identical parts 10a and 10b (the elements of which being distinguished by letters a and b) with its upper link elements 12a and 12b and first attachment elements 13a and 13b visible. Its second attachment elements 11a and 11b are attached to the housing 3 as before. The second linkage 20 lies between the two parts 10a and 1b of the first linkage 10, with its upper link element 18 and second attachment element 17 visible. The two linkages 10 and 20 are fixed to each other by the common right-side pivotal connection 45 (and a similar common hinge at the lower end of the right-side, not visible), or by the first attachment links 13a and 13b of the first linkage and the second attachment element 17 of the second linkage 20 being integrally formed. The lens holder (not shown) is fixed, as before, to the internal face of the left-side link of the second linkage 20. For simplicity, neither the lens holder nor a suitable opening to allow passage of light is shown; in reality both would be present. An indication of the movement of the suspension is given in FIG. 7B.

A yet further embodiment of the invention is shown in the camera of FIGS. 8A and 8B. The arrangement resembles that of FIG. 1B, except that the pivot axes of the pivotal connections extend outwardly of the lens holder 2, rather than around the lens holder 2. In particular, the orientation of the suspension 1 is rotated around the vertical by 90 degrees, so that the pivot axes of the pivotal connections are radial to the optical axis or in other words perpendicular to the tangent to the lens holder 2 instead of being tangential to the lens holder as in FIG. 1B. Since the two attachment members 11 and 13 are no longer parallel to the faces of the housing 3 and lens holder 2 used for attachment in FIG. 1, respective additional lugs 81 and 82 are provided on the housing 3 and lens holder 2 and the attachment members 11 and 13 are attached thereto.

FIG. 8A is a partial top view and FIG. 8B is a schematic side view of this further embodiment of the camera assembly. The camera assembly comprises a suspension 1, a lens holder 2, a housing 3 and an actuator 110. One end 111 of the actuator 110 is fixed to the housing 3 while the other end 112 is attached to the lens holder 2. The actuator extends around the majority of the circumference of the lens holder 2. The suspension 1 lies in the gap between the ends of the actuator 111 and 112. The schematic side view of FIG. 8B is in the direction of the arrow 83 in FIG. 8A. In FIGS. 8A and 8B, the suspension 1 comprises elements 11-14 as shown in FIG. 3B. The second attachment member 11 is fixed to a lug 82 extending from the housing 3, while the first attachment member 13 is fixed to the lug 81 extending from the lens holder 2. The position of the various elements when the actuator is activated to move upwards is indicated by dashed lines.

As described above with reference to FIG. 6, the sideways movement of the suspension 1 can be reduced or eliminated by adding an additional balancing four-bar link to produce the suspension 9 illustrated schematically in FIG. 6A. Two examples of suitable arrangements are shown in FIGS. 9 and 10.

FIG. 9 is a top view in which the suspension 9 is arranged with the two linkages 10 and 20 side-by-side as viewed from above. The first linkage 10 is attached to the housing 3 via lug 82 while the second linkage 20 is attached to the lens holder 2 via lug 81. With this arrangement, very considerable vertical movement of the lens holder is possible without any sideways displacement or rotation of the lens holder.

As described earlier with reference to FIGS. 1 and 2, the lateral stiffness of the suspension increases with increasing length of hinge (or width of link). The width of the link is preferably of the order of 4 mm to provide appropriate stiffness (for a lens holder of diameter of the order of 10 mm). The arrangement of FIG. 9 therefore adds significantly to the bulk of the camera assembly. A more compact embodiment of a balanced suspension is shown in FIGS. 10A and 10B.

FIGS. 10A and 10B are schematic side views in which the suspension 9 is arranged with the two linkages 10 and 20 arranged one on top of the other. The first linkage 10 is attached to the housing 3 via lug 82 while the second linkage 20 is attached to the lens holder 2 via lug 81. At their other ends, the linkages 10 and 20 are fixed together by some means, for example by a linking element 89. In FIG. 10A, the suspension 9 is shown in the inactive state (or in the fully extended downwards state) while in FIG. 10B it is shown extended upwards.

FIGS. 11A and 11B show suspensions 40 and 50 of the same type as the suspension 9 illustrated in FIG. 6A but designed to be manufactured as plastic mouldings. Both suspensions 40 and 50 have an intermediate element 70 interconnecting a first linkage constituted by two link elements 12 and 14 and a second linkage constituted by two link elements 18, 22. All the link elements 12, 14, 18, 22 are integrally formed as a single piece of material with the intermediate element 70 with respective portions 60 therebetween having a smaller thickness than the remainder of the piece of material so that the portions 60 act as pivotal connections.

In the suspension 40 of FIG. 11A, the link elements 12, 14 of the first linkage are connected at the opposite end from the intermediate element 70 to respective attachment portions 71 integrally formed from the same piece of material as the link elements 12, 14 with respective portions 72 therebetween having a smaller thickness than the remainder of the piece of material so that the portions 72 act as pivotal connections. The attachment portions 71 have respective pins 61 and 62 extending from one side (front in FIG. 11A) which may fit into corresponding holes in the camera housing (not shown). The attachment portions 71 are connected together by a tie-bar 66, on the opposite side from the pins 61 and 62, the tie-bar 66 maintaining the vertical separation of the attachment portions 71.

The link elements 18, 22 of the second linkage are interleaved with the link elements 12 and 14 of the first linkage. The link elements 18, 22 are connected at the opposite end from the intermediate element 70 to respective attachment portions 73 integrally formed from the same piece of material as the link elements 18, 22 with respective portions 74 therebetween having a smaller thickness than the remainder of the piece of material so that the portions 74 act as pivotal connections. The attachment portions 73 have respective pins 63 and 64 extending from one side (rear in FIG. 11A) which may fit into corresponding holes in the camera housing (not shown). The attachment portions 73 are connected together by a tie-bar 65, on the opposite side from the pins 63 and 64, the tie-bar 65 maintaining the vertical separation of the attachment portions 71.

The suspension 40 shown in FIG. 11A can be manufactured by plastic injection moulding, by moulding the single piece of material (the link elements 12, 14, 18 and the intermediate element) onto the pins 61 to 64. Alternatively, the single piece of material can be manufactured alone as a simpler injection moulding or by extrusion and cutting, and assembled with the pins and tie-bars.

The suspension 50 of FIG. 11B differs from the suspension 40 of FIG. 11A in that at the opposite end from the intermediate element 70, the link elements 18, 22 of the second linkage are pivotally connected to a first attachment element 11 and the link elements 12 and 14 of the first linkage are pivotally connected to a second attachment element 19. The attachment members 11, 19 are integrally formed with the link elements 12, 14, 18 as a single piece of material with portions 67 therebetween having a smaller thickness than the remainder of the piece of material so that the portions 67 act as pivotal connections. Also, the link elements 12 and 14 are not interleaved with the link elements 18, 22 but instead the link elements 18, 22 of the second linkage are inside the link elements 12, 14 of the first element. The attachment members 11 and 19 are attached to the housing and lens holder (not shown) respectively. This suspension 50 of FIG. 1I B can be readily injection moulded in one piece. The suspension resists twist, tilt and lateral movement, while allowing easy vertical motion.

1. A camera comprising
a support structure;
a lens holder holding at least one lens;
a suspension for mounting said lens holder on the support structure to allow relative movement of the lens holder and the support structure; and
an actuator for moving said lens holder,
wherein the suspension includes two link elements each connected at a first end to the support structure by a pivotal connection and at the other, second end to the lens holder by a pivotal connection, the pivotal connections allowing pivoting of the respective link element around a respective pivot axis, all the pivot axes being parallel, and the extent of the two link elements perpendicular to their respective pivot axes being parallel and of equal length.

2. A camera according to claim 1, wherein the suspension further includes
a first attachment element attached to the support structure, the pivotal connections at the first end of each link element being between the first attachment element and the link elements, and
a second attachment element attached to the lens holder, the pivotal connections at the second end of each link element being between the second attachment element and the link elements.

3. A camera comprising
a support structure;
a lens holder holding at least one lens;
a suspension for mounting said lens holder on the support structure to allow relative movement of the lens holder and the support structure in a movement direction; and
an actuator for moving said lens holder,
wherein the suspension comprises at least two pivotal linkages connected in series between the support structure and the lens holder and interconnected within the series by at least one respective intermediate element, the pivotal linkages being oriented with respect to each other so that the relative movements between the ends of each pivotal linkage in a direction perpendicular to the movement direction compensate for one another,
each pivotal linkage comprising two link elements each having a pivotal connection at a first end of the linkage and a second pivotal connection at the other, second end of the linkage, all the pivotal connections allowing pivoting of the respective link element around a respective pivot axis, all the pivot axes being parallel, and the extent of the two link elements perpendicular to their respective pivot axes being parallel and of equal length.

4. A camera according to claim 3, wherein the suspension consists of two pivotal linkages of the same length arranged antiparallel to one another.

5. A camera according to claim 3, wherein the suspension further includes
a first attachment element attached to the support structure, the pivotal connections at the first end of each link element in the linkage at one end of the series being between the first attachment element and the link elements, and
a second attachment element attached to the lens holder, the pivotal connections at the second end of each link element in the linkage at the other end of the series being between the second attachment element and the link elements.

6. A camera according to claim 2, wherein all said elements of said suspension are formed integrally from one piece of material.

7. A camera according to claim 6, wherein said pivotal connections are formed by portions of said piece of material having a smaller thickness than the remainder of said piece of material.

8. A camera according to claim 7, wherein the thickness of the link elements tapers towards said pivotal connections.

9. A camera according to claim 1, wherein the link elements are made of plastics material.

10. A camera according to claim 1, wherein the pivot axes of the pivotal connections extend around the lens holder.

11. A camera according to claim 1, wherein the pivot axes of the pivotal connections extend outwardly of the lens holder.

12. A camera according to claim 1, wherein the pivotal connections extend along a length which exceeds a tenth of the diameter of the lens holder.

13. A camera according to claim 1, wherein actuator extends around the lens holder leaving a single gap and the suspension is located in said gap.

14. A camera according to claim 1, wherein the suspension connects the support structure and the lens holder within a sector of less than 90 degrees around a central axis of said lens holder.

15. A camera according to claim 1, wherein the lens holder is force-coupled to the housing exclusively through the suspension and the actuator.

16. A camera according to claim 1, wherein the pivotal connections allow an amount of rotational motion limited to less than 20 degrees.

17. A camera according to claim 1, wherein the link elements extend across the entire width of the lens holder.

18. A camera according to claim 1, wherein the actuator is an electro-active actuator.

19. A camera according to claim 18, wherein the actuator is a ceramic actuator.

20. A camera according to claim 18, wherein the actuator is a bender extending in a helix around an axis which is curved.

21. A camera comprising
a support structure;
a lens holder holding at least one lens;
a suspension for mounting said lens holder on the support structure to allow relative movement of the lens holder and the support structure; and
an actuator for moving said lens holder,
wherein the suspension includes at least one pivotal linkage comprising two link elements each having a pivotal connection at a first end of the linkage and a second pivotal connection at the other, second end of the linkage, all the pivotal connections allowing pivoting of the respective link element around a respective pivot axis, all the pivot axes being parallel, and the extent of the two link elements perpendicular to their respective pivot axes being parallel and of equal length.

22. A camera according to claim 21, wherein the suspension comprises a single pivotal linkage connected at a first end to the support structure and at the other, second end to the lens holder.

23. A camera according to claim 22, wherein the suspension comprises at least two pivotal linkages connected in series between the support structure and the lens holder and interconnected within the series by at least one respective intermediate element, the pivotal linkages being oriented with respect to each other so that the relative movements between the ends of each pivotal linkage in a direction perpendicular to the movement direction compensate for one another.
